(19) United States
(12) Patent Application Publication
(10) Pub. No.: US 2003/0024142 A1
(43) Pub. Date: Feb. 6, 2003

(54) Lenticular device containing an integral shuttering method for displaying an image, a series of which form an animated display when moving relative to an observer

(76) Inventor: Michael Killian, Boston, MA (US)

Correspondence Address: MICHAEL KILLIAN, APT 16, 32 WESTLAND AVE, BOSTON, MA, 02115, US

(21) Appl. No.: 09/923,178

(22) Filed: Aug. 6, 2001

(51) Int. Cl. G03B 25/02

(52) U.S. Cl. 40/454

(57) ABSTRACT

A lenticular device with integral shuttering method for displaying an image, a series of which form an animated display when an observer is moving in parallel relative to the device is presented. The shuttering method includes means of displaying an image whereby this image is only viewable by the observer when the observer is positioned on the vertical plane perpendicular to the center of the device. Once the observer moves off this plane by a small fixed angle, the device image is invisible. This method can be employed for placing many devices on the walls of a subway tunnel which will result in an animated image visible to passengers of a subway car moving through the subway tunnel. These images can be illuminated by light from the windows of the subway car or can have their own illumination. The method can be employed on the walls of pedestrian walkways or sidewalks whereby the walking observer will see an animated image.

### FIELD OF THE INVENTION

The present invention relates to image display mechanisms for billboards and signs anywhere the observer is moving relative to said billboard or sign.

### BACKGROUND OF THE INVENTION

There are many methods for displaying images in the prior art. For example most billboards and signs are visible from the vertical plane perpendicular to the center point of the display and at all angles between 0 degrees and 90 degrees to the left and right of this vertical plane.

Lenticular devices containing more than one image with each image visible at specific angle ranges relative to the vertical plane perpendicular to the center of the image are also part of the prior art. For example a lenticular device containing two images is made up of two images divided into many vertical strips and interleaved a strip from one image followed by a strip from another image etc. Overlaid on the interleaved strips are a series of vertical transparent ridges across the whole of the device. These transparent ridges act as lenses offering the observer a view of all the strips relating to either image one or image two. Thus as the user moves parallel to the image changing his/her angle relative to the vertical plane perpendicular to the center of the picture, one image is replaced by another. This mechanism is often used as advertising and has more recently been used for large displays. Lenticular images can be used to provide the perception of motion, for example, in U.S. Pat. No. 3,268,238, entitled “Publications” by R. Finkel there is disclosed an image page formed with lenticular material that utilizes three views of a rabbit. Each view is slightly different from the other views such that rotation of the page generates a visual impression that one or more features of the rabbit move. In U.S. Pat. No. 6,237,264 a lenticular device holding a combination of non moving and moving images is disclosed. Prior art relating to the perception of motion using lenticular devices have focused on placing many images on a single lenticular device. In U.S. Pat. No. 6,237,264 there is a discussion of extinguishing one image prior to displaying another image so that the effect of ghosting between adjacent views is minimized. All lenticular prior art dealing with the perception of motion does so on a single lenticular device. If one were to place a sequence of such devices on a wall then a moving observer would naturally hold his/her eyes onto the first such device instance until the user passes through the full range of viewing angles of that device. The observer in fact would be constantly moving his/her head from side to side and would not perceive motion outside the bounds of one device instance.

There are many methods for shuttering as part of the display of moving pictures in the prior art. For example most movies are displayed using a long strip of film containing successive images. The film strip moves at a fixed speed past a shuttering and light source. As each successive picture frame is directly opposite the shutter; the shutter opens for a fraction of a second and the light source projects the image onto the screen. Fine tuning of the film speed; shutter speed and light source results in an observers perception of continuous motion on the movie screen. The prior art includes a plurality of mechanisms for displaying images on subway tunnel walls that result in the subway car rider perceiving moving pictures. A general mechanism of the prior art includes successive frames mounted on the subway tunnel wall. Lighting is provided either by light sources attached to the frames or by the light sources attached to the moving subway car. For riders of the subway car to see moving pictures through the subway car window as the subway car moves past the fixed frames; there must be a shuttering system. The prior art includes a plurality of mechanisms for shuttering including mechanical systems; optical systems and stroboscopic systems.

### SUMMARY OF THE INVENTION

It is an object of the present invention to provide a lenticular device with integral shuttering mechanism for displaying an image, a series of which form an animated display when moving relative to an observer. It is a more particular object of this invention to provide a lenticular device that holds a representation of a single image. It is a more particular object of this invention to provide an integral shuttering mechanism that allows the image to be visible to an observer at substantially one and only one angle range relative to the vertical plane perpendicular to the center of the center of the display. According to one aspect of the present invention the angle that the image is visible is on the plane that is vertical at 90 degrees from the center of the display. According to one aspect of the present invention once the observer moves 5 degrees off the plane that is vertical at 90 degrees from the center of the image then the image is not visible. An observer moving past a series of these lenticular devices at a certain speed will observe each successive image being visible for a short period of time. From the observer's perspective each successive image is overlaid on exactly the position in space where the previous image was. Thus if a series of images are recordings of successive frames of a movie recording of continuous motion, and the observer is moving at such a speed to observer 16 frames per second, then the observer will perceive continuous motion.

### DESCRIPTION OF THE DRAWINGS

These and other aspects of the present invention will become more evident upon reading the following description of the preferred embodiment in conjunction with the accompanying drawings, in which:

FIG. 1 is a prior art view of a lenticular device containing two images.

FIG. 2 is a prior art view of an enlarged cross-sectional view of a portion of the lenticular device of FIG. 1, illustrating primary and secondary viewing angle ranges of two images.

FIG. 3 illustrates a two dimensional top view of the present invention.

FIG. 4 illustrates a two dimensional top view of the present invention where lenticular lenses are positioned so that the axis plane that passes through each lenticular lens focal line intersect at a line in front of the lenticular device at the ideal viewing position.

FIG. 5 is a two dimensional view of the present invention installed on the walls of a subway tunnel.

### DETAILED DESCRIPTION OF PREFERRED EMBODIMENTS

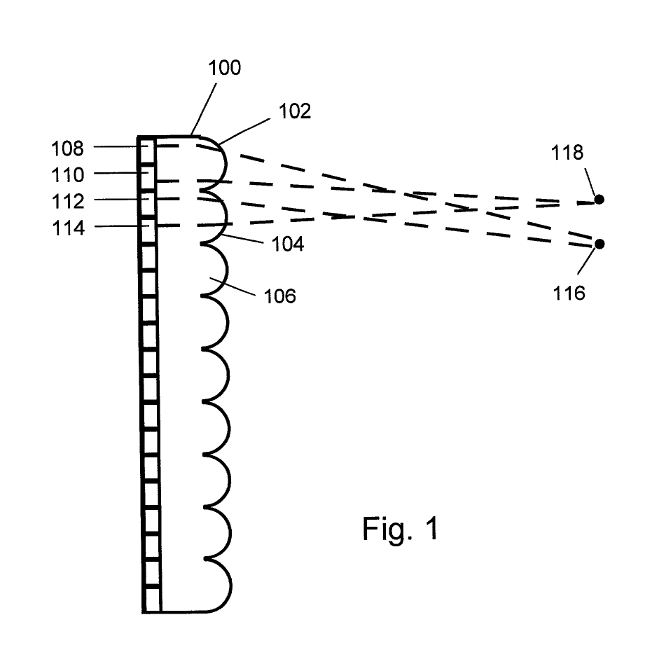

FIG. 1 illustrates a prior art view of the lenticular display of 2 images. In FIG. 1, the lenticular display 100 is made up of a series of vertical transparent ridges 102, 104, 106 etc. which act as convex lenses. The two images in this example are arranged in interleaved strips with strip 108 part of image A; strip 110 part of image B; strip 112 part of image A and strip 114 part of image B etc. When the observer is located at position 116, transparent ridges 102 and 104 focus light reaching the observer to come from strips relating to image A; 108 and 112. When the observer is located at position 118, transparent ridges 102 and 104 focus light reaching the observer to come from strips relating to image B; 110 and 114. Thus both images are visible to the observer dependent on the position of the observer relative to the vertical plane perpendicular to the center point of the image.

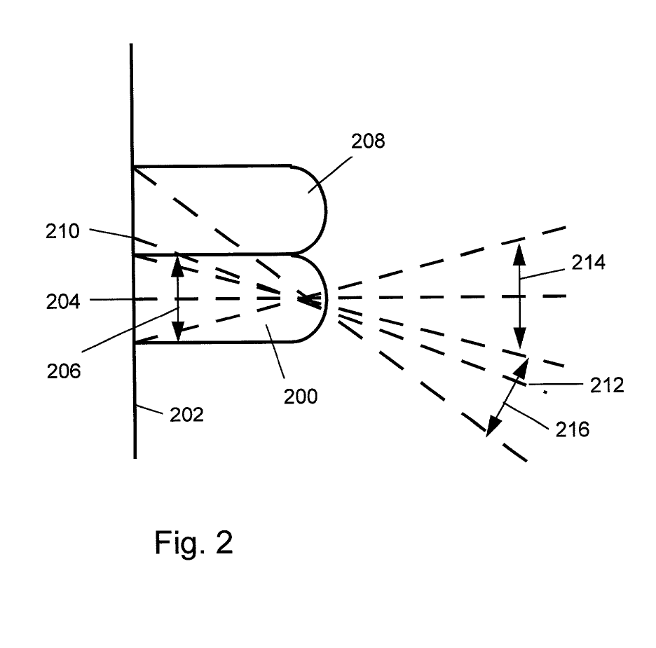

FIG. 2 illustrates an enlarged cross-sectional view of a portion of the lenticular device of FIG. 1, illustrating primary and secondary viewing angle ranges of two images. This effect is illustrated in FIG. 2. Consider a single lenticule 200 with a central view on an image plane 202 at position 204. This central view will be on axis. Behind lenticule 200 within the range designated as 206 two views reside corresponding to different positions. Other views can be found to lie behind lenticule 208 and position 210 is the first such view behind lenticule 208. However, in the viewing angle shown by line 212 position 210 may be seen through lenticule 200 rather than the lenticule 208 which is directly in front of it. The limit of angle which can be viewed and still see views directly behind a designated lenticule is defined as the primary viewing angle shown as 214. There is, however, a secondary viewing angle, designated as 216, corresponding to views all of which lie behind lenticule 208.

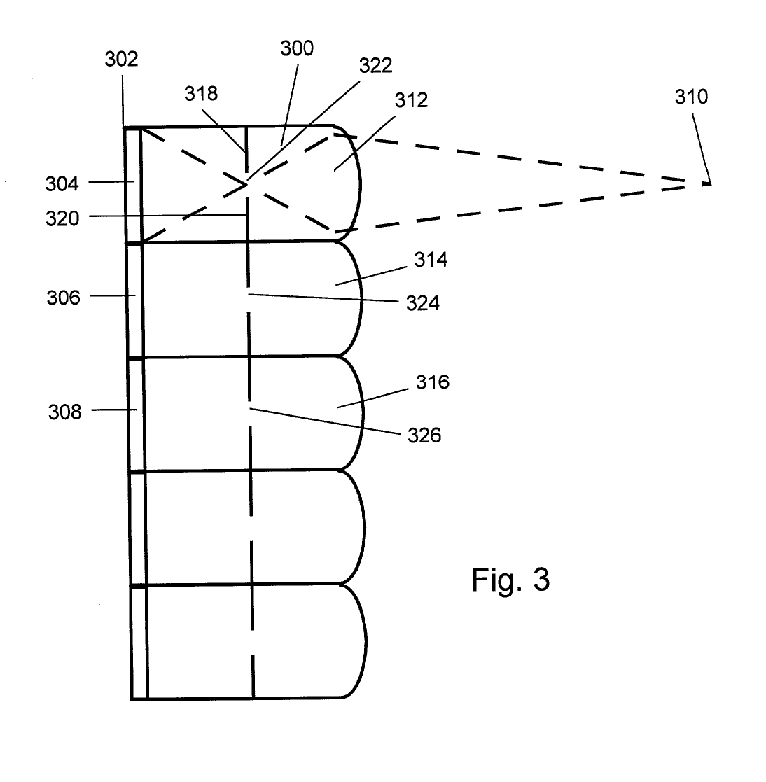

FIG. 3 illustrates a two dimensional top view of one embodiment of the present invention. In FIG. 3, the display 300 contain slices of one image only. In FIG. 3 mirror images of slices of the image are arranged on the image plane 302 as vertical panes 304, 306, 308 etc. Between the image panes and the observer at position 310 there exists a series of vertical lenticular lenses 312, 314, 316 etc. For each image slice there is a related vertical convex lens. Between each image slice and the related convex lens there exists a series of shutters. For example between image pane 304 and lens 312 there exists shutters 318 and 320. These shutters block all light between the image panes and the related convex lens except for a vertical slit opening 322, 324, 326 etc. The position of this slit is on the focal line of the related lenticular convex lens. For example slit 322 between shutter 318 and 320 is at the focal line of lenticular convex lens 312. In one embodiment of the present invention the image panes are at a distance of two times the focal length of the related lenticular convex lens from that lens. In FIG. 3 there is also a series of vertical shutters 328, 330 etc. which block secondary viewing angles and any stray light.

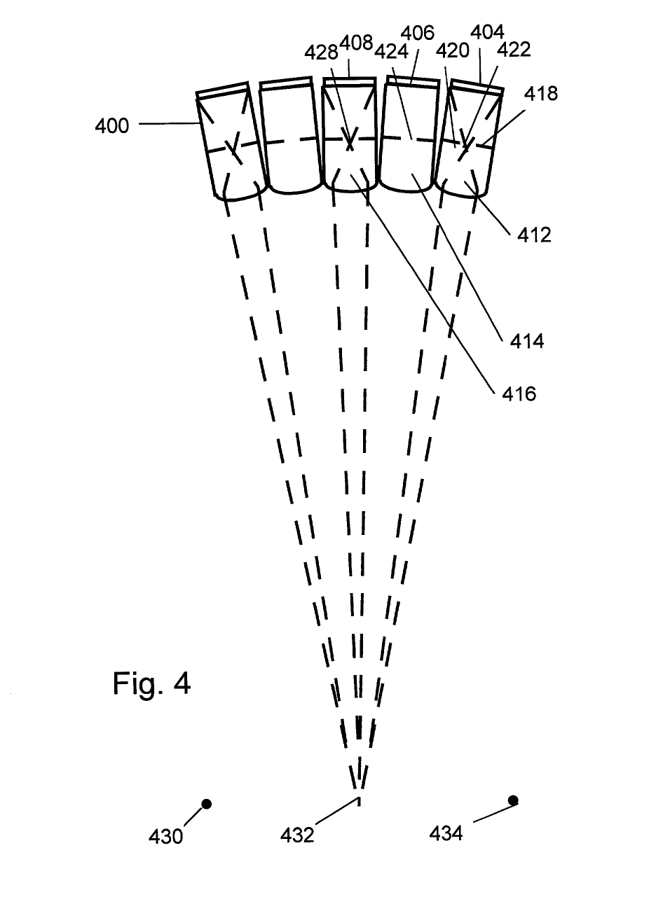

FIG. 4 illustrates a two dimensional top view of the present invention where lenticular lenses are positioned so that the axis plane that passes through each lenticular lens focal line intersect at a line in front of the lenticular device at the ideal viewing position. In FIG. 4, the display 400 contain slices of one image only. In FIG. 4 mirror images of slices of the image are arranged on the vertical panes 404, 406, 408 etc. Between the image panes and the observer at position 410 there exists a series of vertical lenticular lenses 412, 414, 416 etc. For each image slice there is a related vertical convex lens. Between each image slice and the related convex lens there exists a series of shutters. For example between image pane 404 and lens 412 there exists shutters 418 and 420. These shutters block all light between the image panes and the related convex lens except for a vertical slit opening 422, 424, 426 etc. The position of this slit is on the focal line of the related lenticular convex lens. For example slit 422 between shutter 418 and 420 is at the focal line of lenticular convex lens 412. In FIG. 4 there is also a series of vertical shutters 428, 430 etc. which block secondary viewing angles and any stray light. When the observer at position 432 on the vertical plane perpendicular to the center of display 400 and on the horizontal plane perpendicular to the center of display 400, the image from display 400 is visible. This is possible because light from each image pane passes through the slit in front of each pane and then is focused by the convex lens in front of each slit to reach the observer at position 432. For example light from image pane 404 passes through slit 422 between shutters 418 and 420 and is then focused by lenticular convex lens 412 to reach the observer at position 432. When the observer is at position 430 the image contained in display 400 is not visible. At position 430 the observer sees an impression of the various shutters 418, 420 etc. distorted through lenses 412, 414 etc. In this embodiment all shutters are matte black. When the observer is at position 434 the image contained in display 400 is not visible. At position 434 the observer sees an impression of the various shutters 418, 420 etc. distorted through lenses 412, 414 etc.

FIG. 4 exaggerates the thickness of display 400 relative to the distance to the observer at 432 to explain the detail of the invention. In reality for a display of one foot square and a viewing distance of five feet the display should be less than two inches thick. This invention could be developed with custom lenticular displays mounded to include the canting of each lenticular lens so that the axis plane that passes through each lenticular lens focal line intersect at a line in front of the lenticular device at the ideal viewing position. Since currently available lenticule displays from small to large format are made of plastic material it is possible that currently available lenticular sheets could be forced to maintain a curved shape so that the axis plane that passes through each lenticular lens focal line intersect at a line in front of the lenticular device at the ideal viewing position. Bearing in mind that other modifications would have to be made to include the details of this invention to currently available lenticular displays. Images may be printed through the actual device or may be manipulated using computers to generate the mirror image slices of an image.

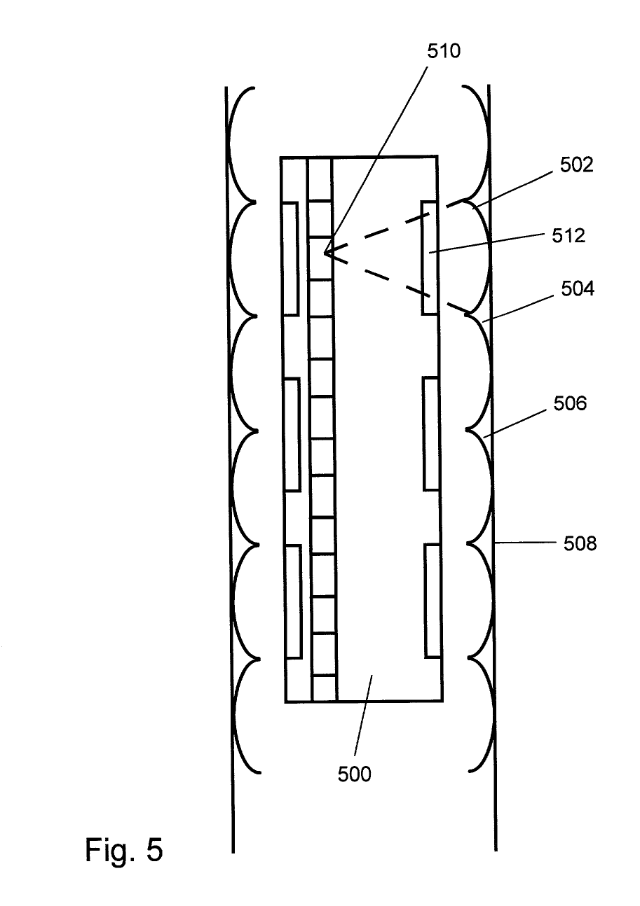

FIG. 5 is a two dimensional view of the present invention installed on the walls of a subway tunnel. In FIG. 5, a subway car 500 moving from top to bottom. A series of individual display elements 502, 504, 506 etc. are mounted on the subway tunnel wall 508 and are specifically tuned to place the ideal viewing position at the seat at the opposite side of the subway car. In FIG. 5 the individual seated at position 510 best represents some of many such ideal viewing positions. For an individual seated at position 510, display 502 is visible through window 512. As subway car 500 move through the tunnel, the observer at position 510 sees images from displays 502, 504 ,506 etc. being visible for a very short period of time. Each successive image is observed in the same position in space relative to the observer at position 510. When the subway car 500 moves at such a speed that the observer at position 510 sees 16 frames per second and each successive display element contains successive frames from a moving picture then the observer at position 510 will perceive moving pictures.

What we claim is:

1. A lenticular device comprising:
a lenticular element having a plurality of lenticular lenses; and
an image holding element holding slices relating to a single image frame; and
an opaque member with a series of lenticular slits between the image assembly element and the lenticular lenses wherein:
said lenticular slits are positioned at the focal plane of each lenticular lens.

2. The lenticular device of claim 1 wherein:
said lenticular lenses are positioned so that the axis plane that passes through each lenticular lens focal line intersect at a line in front of the lenticular device.

3. The lenticular device of claim 2 including:
a series of opaque members that prohibit secondary viewing angles through each lenticular lens.

4. The lenticular device as in claim 3 wherein:
said device is held in their position by a framing structure.

5. The lenticular device as in claim 4 wherein:
a series of said lenticular devices are mounted in sequence.

6. The lenticular device as in claim 5 wherein:
said series of lenticular devices are mounted on the tunnel walls of a subway system.

7. The lenticular device as in claim 5 wherein:
said series of lenticular devices are mounted adjacent to a pedestrian walkway.

8. The lenticular device as in claim 5 wherein:
said series of lenticular devices are mounted adjacent to train tracks.

9. The lenticular device as in claim 5 wherein:
said series of lenticular devices are mounted adjacent to an automobile roadway.

10. The lenticular device as in claim 3 wherein:
said lenticular lenses are a fresnel implementation of lenticular lenses.

11. The lenticular device as in claim 3 wherein:
said lenticular device is illuminated by its own light source.
